(19) United States
(12) Patent Application Publication
(10) Pub. No.: US 2018/0293674 A1
(43) Pub. Date: Oct. 11, 2018

(54) System and Method for Retail Consumers to Purchase Dynamically Priced Wholesale Electricity Generation Services

(71) Applicant: Erik Joseph Bartone, Glastonbury, CT (US)

(72) Inventor: Erik Joseph Bartone, Glastonbury, CT (US)

(21) Appl. No.: 15/485,120

(22) Filed: Apr. 11, 2017

(51) Int. Cl. G06Q 50/06; G06Q 40/04; G01R 21/133

(52) U.S. Cl. CPC G06Q 50/06; G01R 21/1333; G06Q 40/04

(57) ABSTRACT

A system of collecting retail consumer electricity kilowatt hour consumption interval data from the electric distribution company meter, on a real-time basis, at a multiple of locations, for the purpose of procuring and billing interval consumption through a wholesale electricity market managed by an independent system operator and billing those costs to specific customers based on their actual electricity consumption intervals. All customer electricity consumption is collected on a universal time interval and transmitted using cellular or wireless communications to a central data center and energy trading desk. When purchases of interval loads are completed for the day, the data server software allocates aggregate electricity costs back to individual customer accounts based on actual interval loads. Customers have access to real-time consumption and corresponding wholesale prices for purposes of curtailing consumption to reduce electricity interval costs. The system includes a billing mechanism for single rate billing on the electric distribution company utility bill.

The invention is directed toward the efficient acquisition and utilization of retail customer electricity interval kilowatt hour (“KWh”) consumption data for the purpose of enabling individual customer participation and procurement of retail electricity through a retail supplier in the wholesale electricity market(s) managed by the Independent System Operator (“ISO”).

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The electricity generation industry has deregulated in approximately fifteen (15) states throughout the United States. Deregulation of the electric utility industry occurred within the electric generation segment of the industry. The transmission and distribution (“T&D”) components of the electric utility industry (commonly referred to as the “poles and wires business”) generally remains regulated throughout the United States and are provided by the local electric distribution company (referred to as the “EDC”).

The EDCs generally continue to own and maintain the retail customer (“customer” and “consumer” are interchangeable) electric meter (referred to as the “revenue meter”). The revenue meter is the basis for measuring retail customer electricity consumption for both the deregulated electricity generation market and the regulated transmission and distribution utility services.

States that have deregulated the electric generation market allow retail consumers to purchase competitive electricity from third-party supplier(s) (herein referred to as “retail supplier(s)”) or to receive their generation service from their EDC (EDC electric generation rates are commonly referred to as “Standard Offer” or “Standard Service” generation service rate(s)). An EDC's customer base, being served by Standard Offer or Standard Service generation rate(s), is generally made up of retail customers within the EDC's franchise service territory that have chosen to remain with the EDC for purposes of electric generation service and retail customers that may have previously been served by a retail supplier but have chosen to switch back to their EDC for electric generation service. EDC's commonly provide Standard Offer generation services by procuring an aggregate portfolio of customers being served over an established time period.

For the most part EDC's Standard Offer generation service rates are fixed-price full requirements rates. Standard Offer electricity generation is provided at a fixed price per kilowatt hour (“KWh”) for all KWhs consumed during a billing period regardless of the retail consumer's electricity consumption profile. An electricity consumption profile is a finite measurement of KWhs consumed during pre-determined time intervals (hourly or shorter) throughout a day. On a limited basis, EDCs may offer a variable price Standard Offer rate. These rates are generally described as a “hybrid” fixed price offer where a higher fixed price is established during on-peak hours (generally weekday periods from noon to 6 pm) and a second fixed price is established for all other off-peak hours. These EDC price options are in no way associated or linked with the dynamic pricing wholesale electricity generation market that currently is operated and managed by a regional independent system operator (“ISO”) (of which this invention enables retail customers to choose as an option). In the dynamic wholesale electric market(s), retail customers would be directly exposed to wholesale electricity prices that fluctuate in pre-determined time intervals (hourly or shorter) and where customer's actual electric consumption intervals are captured, measured, and used to procure (“settle”) through the ISO market(s).

In deregulated states, retail customers are also offered the option to competitively shop for electric generation services through third-party retail suppliers, aggregators, and other licensed entities in the business of providing retail electricity generation services or components thereof. In general, the competitive supply market offers very limited “fixed” price offers to retail customers. These fixed price offers are similar to the EDC's fixed price Standard Offer or Standard Service generation rates. These fixed price electric generation service offers provide no incentive for retail consumers to change behavior with respect to electricity consumption. Consumers within similar market segments tend to have similar electricity consumption patterns. As such, the electric generation system is forced to construct more generating capacity to meet coincident peak demand profiles resulting in poor utilization of generating resources and higher costs. A retail electric generation solution that introduces dynamic wholesale prices that change on an hourly, or shorter basis, will create the incentive for the consumer to change consumption behavior as they will have a direct financial incentive to do so. This invention provides a cost effective and unique system to provide retail consumers with the ability to actively purchase dynamic priced electricity from the wholesale electric market(s).

The primary reason why the electricity generation industry has not offered more dynamic retail pricing options in the competitive electric generation market is due to the fact that the EDC currently owns, operates (reads) and maintains the customer electricity revenue meter and collects customer meter data on a monthly basis for purposes of billing their transmission and distribution services. The EDC may collect customer meter data from the revenue meter on a daily basis, however, this data is not accessible nor used to maximize customer participation in the dynamic wholesale electric generation market(s) as the EDCs have no incentive to do so. The EDC has virtually no incentive, as it is not in the electric generation business, to collect customer electric meter data in a way that facilitates the electricity generation market to offer more dynamic electricity pricing options or for retail customers to participate directly in the wholesale electricity market. The T&D components of electric service are dictated by regulated rate tariffs approved by each state utility regulatory authority.

These rate tariffs rarely, if ever, fully align with the infrastructure and timely meter data retrieval requirements necessary for a retail customer to participate in the dynamic wholesale electric generation market. For example, the EDC may only need to collect electric consumption data for a retail customer it serves by reading the electric meter once a month (end of billing cycle) and use that information to generate an electricity bill for T&D electric service. If this retail customer is currently served by a retail supplier, the month end electricity data, collected by the EDC, would be sent to the retail supplier within a few days of the meter read. By receiving this meter data a couple of days after the end of the billing cycle month, the retail supplier has no ability to offer the retail customer an option to participate in a dynamic wholesale electric market that establishes prices in real-time and in hourly or shorter intervals.

EDC's have a variety of revenue meters with varying levels of functionality installed at retail customer locations. Some meters have the ability to collect only kilowatt hours, other meters collect kilowatt hours and will collect the interval peak demand (KW) during a billing cycle period, and other more sophisticated meters will collect electricity KWh interval data. The types of electric meters and the data collection capabilities vary depending upon a multiple of factors including, but not limited to: (1) the specific T&D rate tariff the customer is assigned to, (2) the associated billing parameters that are used to determine specific T&D rate tariff charges, and (3) the current plan for smart meter deployment by the EDC and approvals from the state regulatory agenc(ies).

The EDC's current method of collecting and disseminating individual retail electric customer meter data on a monthly basis prevents and inhibits a retail supplier from actively procuring a customer's electricity KWh consumption in the wholesale electric generation market(s). On a monthly basis, the EDC reads the customer's electric meter and either: (1) sends the quantity of kilowatt hours for that particular billing cycle to the assigned retail supplier for purposes of billing the customer, or (2) the EDC bills the customer the quoted fixed Standard Offer price for electric generation service if the customer is being served by the EDC.

The wholesale electricity generation market(s) include active and dynamic participation from the supply (generation) side of the wholesale electric generation market. The wholesale supply side of the market includes the collection of ISO members that own and operate the electricity generating facilities within the ISO service territory. The demand side of the market (retail electricity consumption) is made up of retail consumers that currently rely on the electricity grid for electricity requirements. The demand side of the market relies on the instantaneous delivery (electric generation) to meet instantaneous aggregate demand of consumer's electricity needs. The demand side of the wholesale market is comprised of licensed retail supplier(s) and EDCs providing Standard Offer service but with no direct participation from retail customers (demand).

The wholesale electric generation market is a highly competitive, fluid, and dynamically priced active market. The wholesale markets comprise both a day-ahead and a real-time competitive market. In these markets, both supply and demand resources competitively bid resource capacity (in the form of megawatts and megawatt hours) into the day-ahead and real-time markets. Competitive bids and prices are done on interval periods on an hourly or shorter basis depending upon the component of generation service. As such, the wholesale electricity prices that are both bid and accepted are dynamic in nature and change on an interval basis. Changes in the electric prices are based on a competitive market managed by the ISO whereby electric generation resource(s) (supply) is matched with aggregate consumer electricity consumption (demand). Prices are established in particular intervals at the “margin” whereby the highest bid price necessary to meet both anticipated consumer demand (day-ahead market) and real-time customer electricity demand (real-time market) is the resource that establishes the market clearing price for electric generation resources for that particular interval.

In order for individual customers to purchase dynamically priced wholesale electricity, they must have the following infrastructure in place: (1) EDC meter that collects electric consumption in intervals (typically 15-minute intervals), (2) an EDC approved connection (typically a pulse output protector or equivalent device) to the customer revenue meter to extract the customer interval data from the EDC meter, (3) a data collection and data transmission device to send customer interval data on a real-time basis to a central data server, (4) a data server and energy trading desk that can organize customer electric interval data and aggregate with multiple customer consumption intervals in order for a, (5) retail supplier to procure electric power in the wholesale electric market(s) using actual customer electric consumption interval data, (6) a retail supplier that can send and receive customer electric interval data to and from the ISO and EDC for purposes of validating the clearing and settlement of customer electricity consumption reconciled to the EDC revenue meter data, and (7) a retail supplier that can invoice individual customer electric generation service directly or develop an aggregate monthly market price for electricity generation service to be billed on the EDC utility bill.

Retail electricity consumers have virtually no ability to purchase power directly from the wholesale markets because of the current inability to efficiently extract, receive, and manage metered electricity interval consumption on a timely basis for purposes of procuring and clearing actual loads in the wholesale electricity market. Because the EDC reads the vast majority of electricity consumer meters on a monthly basis, these customers cannot receive dynamic pricing options or pricing signals from retail supplier(s). The retail supplier cannot obtain customer consumption interval data on a real-time basis from the EDC and as a result has no ability to provide dynamic pricing options to its customers and no ability to purchase metered customer electricity KWh consumption in the wholesale electric market(s).

Retail suppliers who serve retail electricity consumers that do not have revenue meters that collect actual electricity KWh interval data, purchase electricity on behalf of those retail customers based on the T&D rate tariff load profile (referred to as “standard rate tariff load shapes”) assigned to the customer by the EDC. Standard rate tariff load shapes are established by the EDC(s) (see FIG. 6 for sample published standard rate tariff load shape published by EDC). Standard rate tariff load shapes represent an aggregate daily consumption profile for customers assigned to a specific T&D rate tariff. EDCs typically have several, if not dozens of T&D rate tariffs and are based on various customer classes and customer segments. These customer classes typically include residential consumers, small and medium commercial and industrial users, schools, street lighting, and many more. Standard rate tariff load shapes are derived by the EDC based on an aggregate typical energy consumption profile made up of many customers within the rate tariff class. These standard rate tariff load shapes change on a monthly basis based on historical electricity consumption interval data of sampled customer's energy consumption. The EDC's T&D rate tariffs are designed with a multiple of billing parameters that range from a fixed monthly customer service charge, kilowatt hour (KWh) charge(s), and peak demand (KW) charges and are based upon studies associated with the cost to serve these customer classes and the required collection of T&D charges necessary to recoup the costs to provide T&D service. This same methodology is applied to the generation service component.

Because retail suppliers cannot receive individual customer electric interval data on a timely basis, or at all depending upon the data collection capabilities of the EDC electric meter, the retail supplier is purchasing wholesale electricity from the ISO wholesale market based on the customer's T&D standard rate tariff load shape.

Because individual customer load profiles can vary substantially from the standard rate tariff load shape, individual customers are cross subsidizing other customers within an EDC service territory. In addition, if the customer is not able to see and link their actual electric KWh consumption and a dynamic price for that interval in a timely manner, there is little to no incentive for customers to change behavior, change their electricity consumption patterns, or react to market pricing signals. As a result, electricity consumers are content with receiving fixed price per kilowatt hour contracts from their EDC or retail supplier(s) even though these prices are higher than what the market should be paying where electric demand resources can react to dynamic pricing signals from the electric supply side of the market. In addition, standard offer rates and retail supplier fixed prices tend to be higher than the long-term average market clearing prices in the wholesale electric market because of the cross-subsidization amongst customers due to the lack of specific customer electricity consumption loads being matched against corresponding market prices and the assignment of those customer loads to various retail suppliers and EDC stand offer portfolio(s).

BRIEF SUMMARY OF THE INVENTION

The present invention relates to the field of retail consumer electricity procurement directly in the wholesale electricity markets with dynamic pricing and a mechanism to collect and clear actual retail customer electricity kilowatt hour (“KWh”) consumption interval loads in the wholesale market(s) on a timely basis.

An illustrative embodiment of the present invention (FIG. 1) includes the collective infrastructure of acquiring customer electricity consumption interval data from the EDC revenue meter on a real-time basis via a local pulse-output protector (LPOP) or equivalent meter connection and an onsite data storage and communications module used to collect and store electricity consumption interval data. Customer interval data is sent to a central data server and trading desk on a real-time basis from a wireless cellular or internet connection. The trading desk utilizes customer consumption interval data on an individual customer basis and a plurality of customers to procure electricity in the wholesale electric market(s) whereby actual customer electricity load consumption is matched with corresponding wholesale electric supply prices.

Currently, retail customers cannot efficiently or cost effectively procure their electricity consumption in the wholesale market because they are unable to obtain their EDC metered consumption interval data in a timely manner that facilitates the ability to procure power in the ISO whole electricity market on an hourly and more finite basis as dictated by ISO wholesale purchasing rule(s). In addition, customers that do not have an EDC meter that captures and collects consumption interval data are profiled using standard rate tariff load shapes established by the EDC T&D rate tariffs (illustrated in FIG. 6) for purposes of purchasing retail electricity generation services from retail suppliers as well as through EDC standard offer service. As such, these customer's actual electricity consumption interval profiles could be completely different from standard rate tariff load shapes and result in paying more or less for electric generation services compared to their actual cost to serve. The present invention includes the collection and utilization of customer's real-time actual electric consumption intervals to procure and clear against corresponding dynamic wholesale electricity prices through the ISO wholesale market(s) eliminating the need to rely on standard rate tariff load shapes.

The present invention includes proprietary software that provides customers with web accessible interval consumption KWh data and corresponding dynamic wholesale price signals. This information allows customers to receive real-time feedback of their actual electricity consumption, corresponding wholesale market clearing price(s), and total cost of electric generation service for specific interval period(s) throughout the day. This system enables retail customers to directly control and mitigate electricity generation costs by curtailing or shifting energy consumption from high priced intervals or curtailing electricity consumption during an ISO system peak day whereby customer's capacity requirements are set for the following year. The software provides customers with both computer and phone application alerts (illustrated in FIG. 13) for high priced wholesale electricity intervals. The software provides customers with online secure access to their customer account where they can view their electricity consumption and corresponding wholesale electricity purchase prices paid (illustrated in FIG. 14 & FIG. 15).

The invention includes software that collects aggregate wholesale electricity purchases from daily time intervals from a plurality of customers being served by a retail supplier and allocate(s) those costs to individual customer accounts based upon individual customer electricity KWh consumption interval profiles and corresponding wholesale interval prices (illustrated in FIG. 11).

The invention allows a retail supplier to offer dynamic wholesale pricing and market participation to a retail customer and a plurality of retail customer(s) and bill for electric generation services on the EDC monthly utility bill. Customers have the option of receiving a separate electricity generation service bill from their retail supplier or have the retail supplier include their charges on the EDC monthly T&D utility bill. If the customer opts for receiving a single utility bill with both charges, the retail supplier must provide the EDC with a single rate per kilowatt hour for purposes of billing on the EDC bill. The data server software collects individual customer interval consumption and corresponding wholesale prices and aggregates the customer's electricity consumption for the EDC billing period and wholesale electricity prices paid and generates an average price for the EDC billing period which is sent to the EDC for inclusion on their utility bill (FIG. 10). This mechanism allows for the retail customer to purchase electricity on an interval basis throughout a billing period yet receive a single monthly bill from their EDC for both electricity generation and T&D charges.

The software includes a module that incorporates ISO load forecast data along with weather forecast data collected by the central data server from independent sources. The software analyzes various weather forecast patterns including temperature data and relative humidity data and weather tracks along with geographic load concentrations to predict and determine hourly interval periods to which an ISO System Peak may occur. The software incorporates web and phone application alerts (FIG. 13) along with recommended interval periods for curtailment by customer(s) in order for the customer(s) to minimize electricity generation capacity charges. This component of the invention is a comprehensive part of the embodiment of the system to allow retail consumers the ability to directly participate in the wholesale market and the various mechanisms of reducing overall electric generation component costs that are not otherwise available under the current retail pricing structure(s).

The invention software includes a module that provides customers with a web accessible chart of posted ISO day-ahead hourly prices for electricity. Customers can utilize this information to choose to purchase their next day forecasted electricity consumption in either the ISO day-ahead market or purchase in the real-time market or a combination of both. Customers can utilize this information to better plan their electricity usage pattern based on the hourly price variations in the day-ahead market (FIG. 16).

### BRIEF DESCRIPTION OF THE SEVERAL VIEWS OF THE DRAWING

FIG. 1 is a block diagram of the system and methods of allowing retail customers the unique, singular and the aggregate ability to procure their real-time and actual electricity KWh consumption interval(s) directly in the wholesale electricity market(s) according to the present invention. The system and method comprises a group of critical components and processes combined together to enable the unique ability for retail customers of all sizes including, but not limited to: small commercial, industrial, institutional, and residential electricity customers as well as medium and large electricity users to purchase dynamically priced wholesale electric generation services.

FIG. 2 is a block layout diagram of the EDC approved isolated pulse output protector (commonly referred to as an “LPOP”) or equivalent device that meters electricity consumption through the EDC revenue meter and collects electricity usage on a real-time basis for the purposes of measuring electricity consumption in pre-defined time intervals. The block diagram illustration shows a hard-wired connection from the EDC LPOP to a solid-state data storage & communications module. Electricity consumption data from the EDC revenue meter is captured in the form of meter pulses by the EDC LPOP or equivalent EDC approved device and transferred to a solid-state data storage & communications module electronically. The solid-state data storage & communications module collects meter pulses from the EDC LPOP and records them for a specific time stamped interval and sends the interval data through a wireless cellular or internet hard-wire connection to a retail supplier data center and trading desk.

FIG. 3 illustrates the system's ability to establish identical time interval periods for the collection of electricity KWh consumption for a plurality of customers in differing locations within an ISO geographic zone. Individual customer solid-state data storage & communications modules receive updated time stamps from the retail supplier data center astronomical clock via the wireless connection to ensure that all customer time intervals are consistent for purposes of aggregating electricity consumption intervals and procuring such intervals in the wholesale electricity market(s).

FIG. 4 illustrates the data components collected for each customer location as part of the customer acquisition and setup process by the retail supplier. A portion of the illustrated data points are collected during the time of customer acquisition and setup and certain information collected as part of the transmission of customer electricity KWh interval data from the solid-state data storage & communication module to the retail supplier data server. Collection of customer data is critical to establishing customer record keeping, allocation of wholesale electricity purchase costs, and billing and collection protocols.

FIG. 5 illustrates sample actual electricity KWh interval data retrieved from the customer location to the retail supplier data server via the system outlined in FIG. 2. The illustration is of a customer that is a small commercial electricity user being served by an EDC's Small General Service T&D rate tariff. For illustrative purposes and to reduce the number of intervals shown, the time interval data is shown hourly. For purposes of electricity trading, the time intervals will be as low as 5-minute intervals with typical intervals being 15-minutes. This illustration shows the customer's electricity load profile based on actual electricity consumed for the sample week day. The actual customer electricity KWh interval consumption is collected and used to procure electricity generation services in the wholesale ISO market(s).

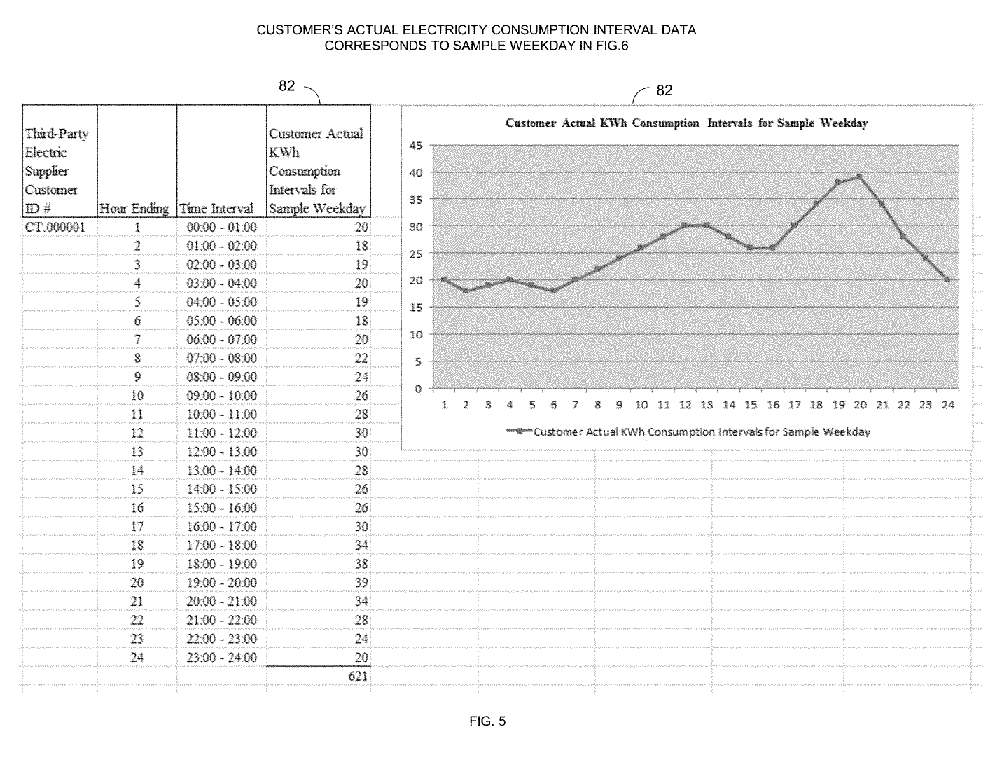

FIG. 6 illustrates an EDC's published standard rate tariff load shape for a customer being served under their Small General Service T&D rate tariff (T&D rate tariff applicable to customer illustrated in FIG. 5). The standard rate tariff load shape is used to determine a customer's allocated share of electricity generation service charges if this customer were receiving electricity generation service from the EDC under its Standard Offer. If this customer were to be served by a retail supplier who does not have access to the customer's actual KWh consumption interval data, the retail supplier would utilize the EDC's published standard rate tariff load shape for purposes of procuring wholesale electricity for the customer.

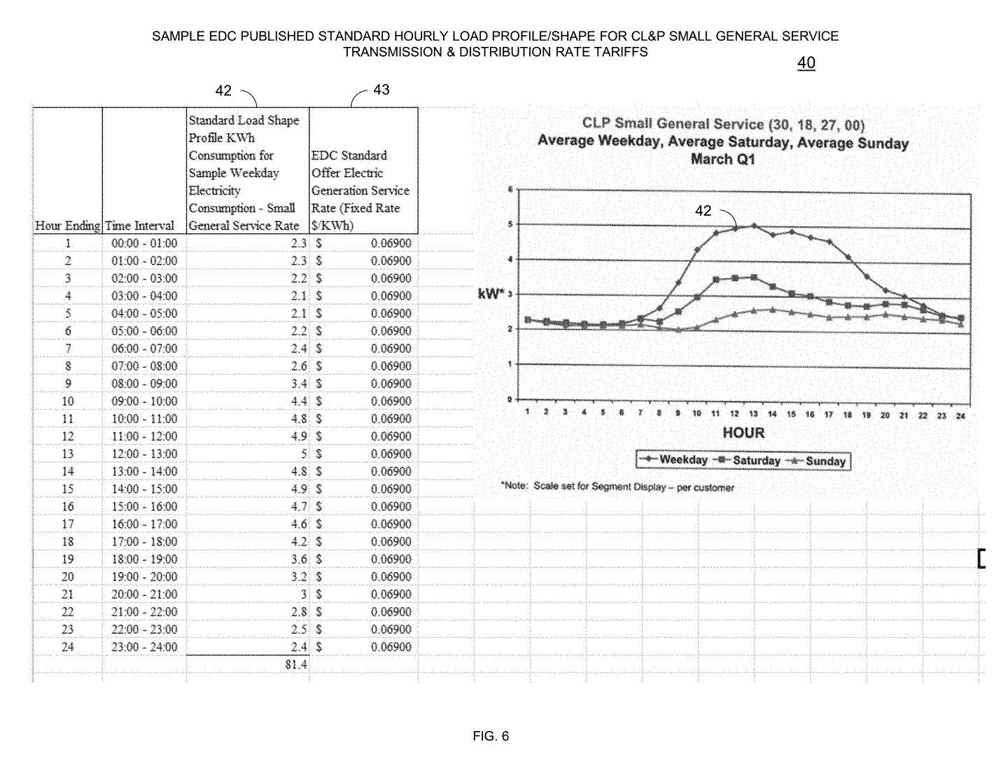

FIG. 7 illustrates the real-time dynamic price of wholesale electricity from the ISO for the hourly intervals of the sample week day illustrated in FIG. 5 and FIG. 6. Real-Time prices from the ISO are shown on an hourly basis for illustrative purposes. For purposes of electricity trading, the time intervals will be as low as 5-minute intervals with typical intervals being 15-minutes depending upon the varying sub-components of electric generation services.

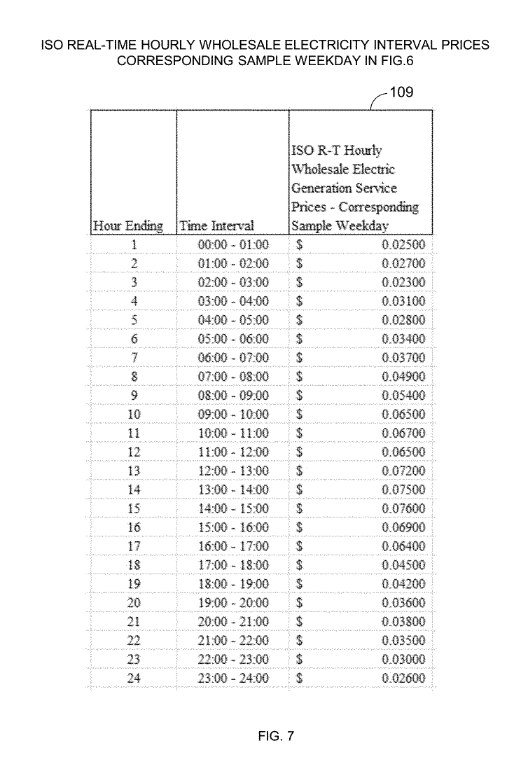

FIG. 8 illustrates the ISO real-time market hourly price and total cost of the Customer purchasing electricity in the wholesale ISO Real-Time market if the Customer was capturing actual electricity consumption intervals from the EDC meter and procuring electricity generation services with corresponding ISO wholesale real-time prices for those same intervals.

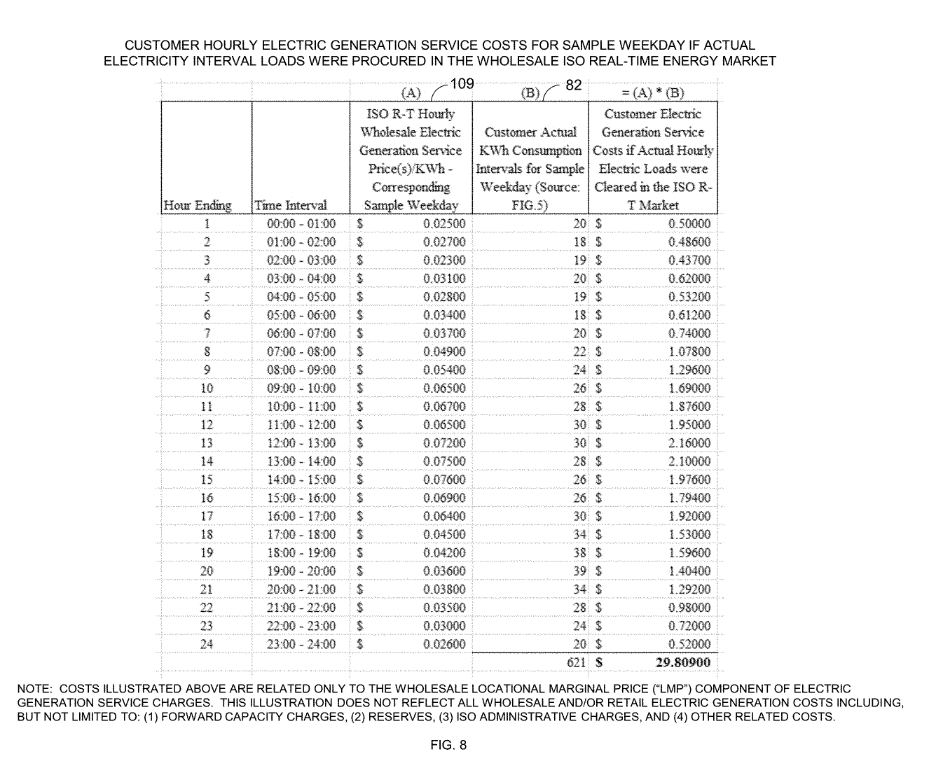

FIG. 9 illustrates the varying costs of electricity generation for a particular day (same day and customer as illustrated in FIGS. 5, 6, 7, and 8) depending upon the how Customer electricity generation service is purchased. The illustration first shows how a customer's daily electricity usage would be allocated to each of the twenty-four hourly intervals based upon the standard rate tariff load shape determined by the EDC's published T&D rate tariff. As illustrated, the customer's actual electricity consumption intervals are different than the standard load profile. The illustration shows the hourly price and total cost of the Customer purchasing electricity in the wholesale ISO Real-Time market if the Customer was able to clear its actual electricity consumption with corresponding ISO real-time prices for those same intervals (also shown in FIG. 8). The illustration shows how the Customer would be charged if the Customer's hourly electricity consumption intervals were determined by the standard rate tariff load shape and those loads were procured in the ISO Real-Time market. In this illustration, the Customer pays a higher daily costs compared to the first scenario. This is a result of the customer's actual load profile being different from the standard rate tariff load shape with differing wholesale prices throughout the hourly intervals. The last scenario shows the customer's daily cost if they chose to purchase their electric generation service from the EDC's Standard Offer service rate. As illustrated, all three scenarios result in differing daily electricity costs but with all three scenarios using the identical number of KWhs consumed for the day.

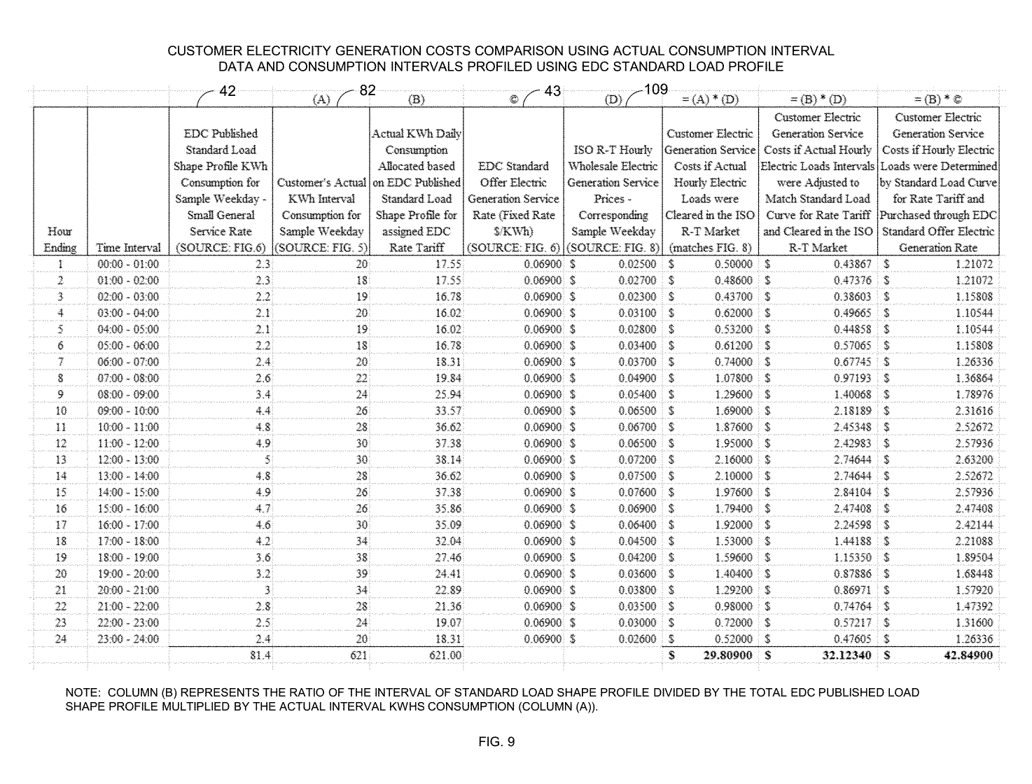

FIG. 10 illustrates how the invention allows retail customers to participate in the wholesale electric generation market(s) with a retail supplier utilizing actual electric KWh consumption intervals and clearing those loads through the ISO Real-Time or Day-Ahead market. The data server software tracks individual customer interval consumption and associated costs and aggregates those costs for the month that corresponds with the EDC revenue meter billing cycle. Since customer KWh consumption interval data is collected from the EDC revenue meter, customer consumption data matches with the EDC's metered KWh consumption. This system uniquely collects both interval consumption, corresponding ISO wholesale costs for the interval(s) and derives a single aggregate price per KWh for the total number of intervals in the billing cycle that are billed on the EDC monthly electric bill.

FIG. 11 illustrates how a plurality of retail customer electric KWh interval data is collected in real-time and aggregated into a central data server database of a retail supplier. The illustration provides detail of how a portion of the aggregate customer interval loads are bid into the ISO Day-Ahead market and the remaining portion of the interval loads are cleared in the ISO Real-Time market. The illustration provides a detail of electric generation prices and costs being incurred for the procurement of the load intervals in the Day-Ahead and Real-Time market(s) and a total electric generation cost incurred for the sample day by the retail supplier utilizing actual customer electricity consumption interval data.

FIG. 12 illustrates the predictive modeling algorithm for individual customer electric loads used to forecast “next day” customer electricity consumption intervals for the purpose of procuring electricity in the ISO Day-Ahead and Real-Time market(s).

FIG. 13 provides an illustration of the web-based phone application utilized by retail customers for purposes of being able to visually see their facility electricity consumption in real time intervals. The illustration shows customer access to the real-time ISO market clearing price and electricity curtailment alerts associated with an ISO System Peak Day where a customer's capacity tag is set for the following year.

FIG. 14 illustrates the customer web-based dashboard tab that provides detailed information of the interval prices paid for electric generation throughout the current billing month. Daily prices are compiled for each pricing interval and are color coded so that customers can visually see the changes in market clearing prices paid during each interval.

FIG. 15 illustrates the customer web-based dashboard tab that provides detailed information of the total cost of electric generation paid by the customer for the specific intervals throughout the day. Total electric generation costs are derived from the interval market clearing prices plus an allocation of ancillary charges, including but not limited to: (1) electric generation capacity charges (I-CAP), (2) ISO reserves, (3) NCPC (“Net Commitment Period Charges”) charges, (4) Ancillary and administrative charges, and (5) other ISO or competitive market fees and charges.

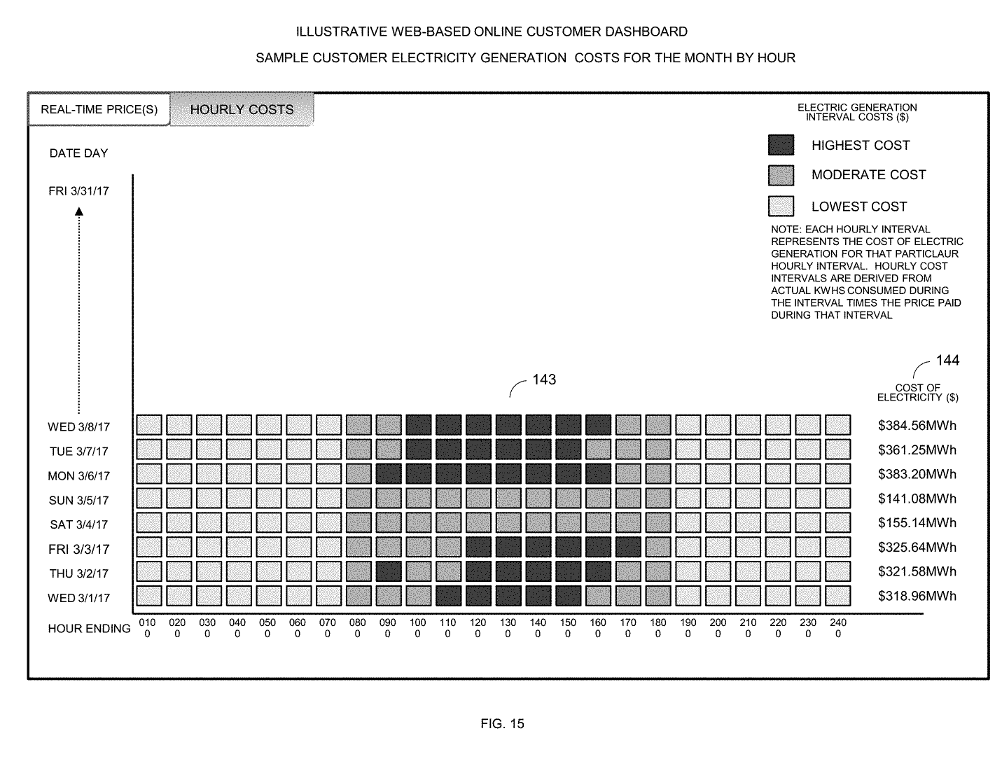

FIG. 16 illustrates a customer's access to a web-based dashboard that posts the day-ahead ISO wholesale market clearing prices for the next day twenty-four (24) hourly intervals. Customers can view day-ahead dynamic interval prices and the variations by hour. These price signals can be utilized by the customer to plan electricity usage strategies and decide whether to participate (accept the day-ahead prices) in the day-ahead market or wait and participate in the real-time market where prices are determined based upon actual aggregate system demand.

### DETAILED DESCRIPTION OF THE INVENTION

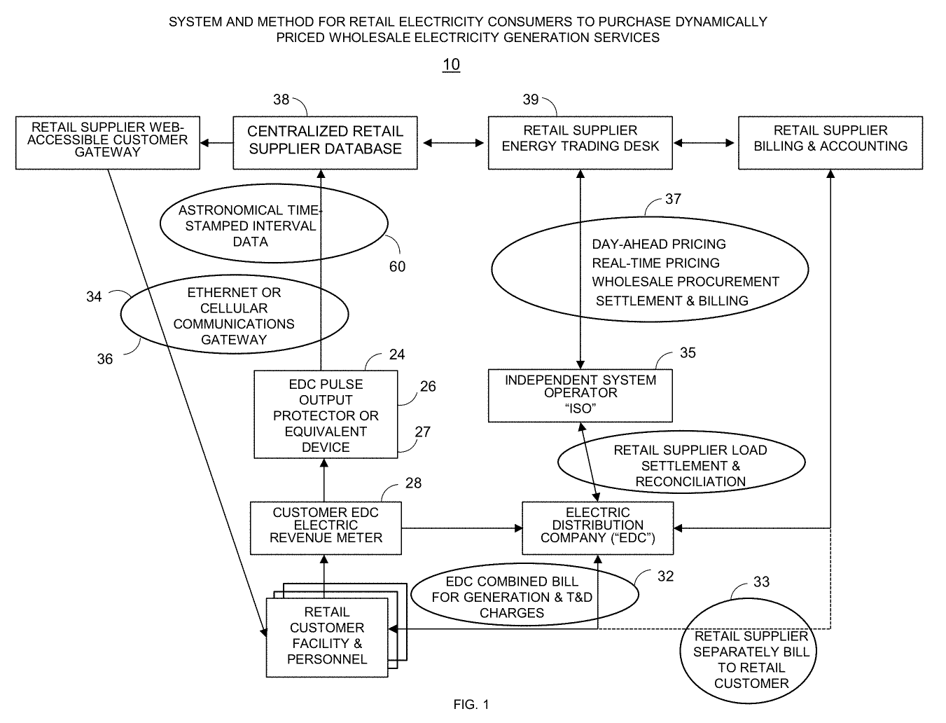

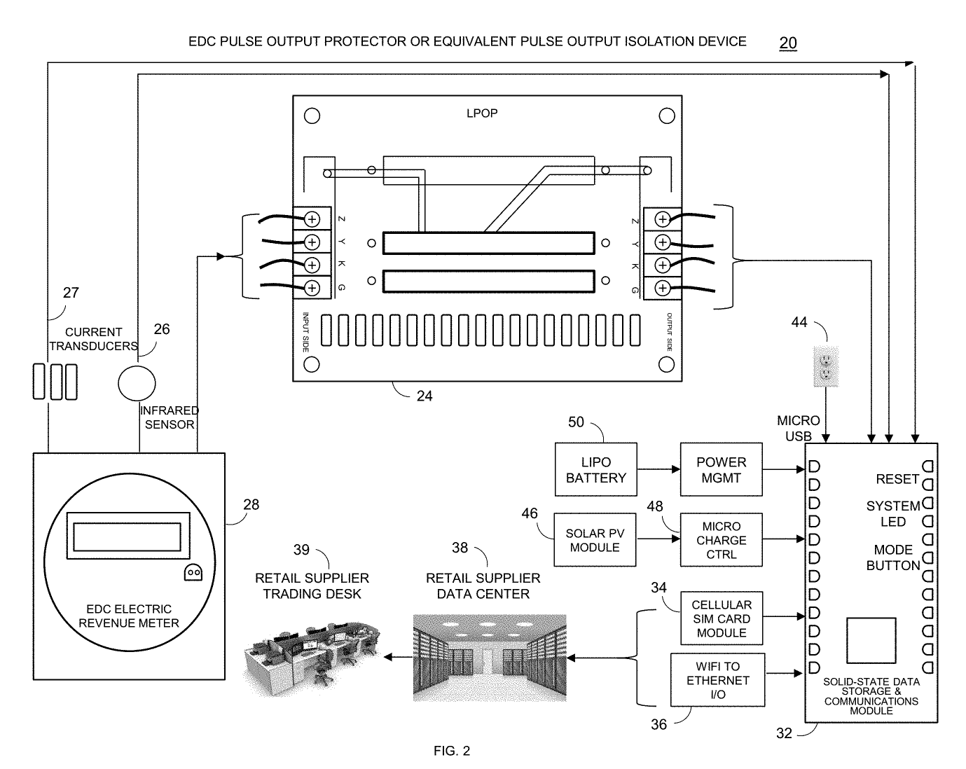

FIG. 1 shows a collective system 10 of acquiring customer (or a plurality of customers) electricity KWh consumption on a real-time continuous basis from the EDC revenue meter and utilizing customer's metered electricity interval consumption for purposes of purchasing in the ISO wholesale electricity generation market(s) in accordance with the present invention. The invention utilizes a utility approved LPOP (“Local Pulse Output Protector”) 24 or equivalent interface 26 27 with the EDC revenue meter (FIG. 2). The invention specifically addresses the need to acquire customer electricity KWh interval data from the EDC revenue meter 28 as the basis for procuring customer electricity interval loads in the ISO wholesale electric generation market(s). This is an important feature of the invention because the EDC currently serves electricity generation services to a portion of their customers through standard offer 43 service. As such, the EDC needs to disaggregate and assign electricity loads to independent retail suppliers that are serving customers in their franchise service territory. The methodology of disaggregating their loads is based on customer's metered data collected from the EDC revenue meter. When a customer selects to receive electricity generation services from a retail supplier independent of the EDC, the EDC “assigns” the customer to the designated retail supplier for purposes of tracking and assigning customer electricity consumption (and associated costs to serve the customer) and for the purpose of accurately isolating customer electricity consumption for those customers that remain with the EDC.

The system's 10 efficient collection of customer KWh consumption interval data is a critical feature of the invention as retail suppliers have the option of billing their electricity generation services on the EDC's monthly transmission and distribution bill 32. The EDC uses the customer's revenue meter consumption as the basis of billing its transmission and distribution services (through state public utility regulatory body(ies) regulated transmission and distribution rate tariff charges) which is correspondingly used by the retail electric supplier to bill electric generation services to the same customer. KWh consumption data for both components of the bill must match and coincide. The retail supplier also has the option of billing its customers separately from the EDC bill 33.

Currently, if a customer does not have an EDC interval meter, or if the EDC does not collect the interval data for purposes of billing transmission and distribution charges, the customer will purchase its electric generation service(s) as a “profiled” customer 40. A customer that falls into this category would purchase their electricity generation service whereby their electricity KWh interval consumption is assumed to match the standard rate tariff load shape 42 determined by the EDC for their respective EDC T&D rate tariff. Customers that purchase electricity generation services based upon an assigned standard rate tariff load shape may or may not be paying more for electric generation service compared to their actual consumption intervals 82. For example, a residential customer that has a solar photovoltaic system that serves a portion of their electricity demand produces onsite electricity during the daylight hours and the customer relies on the utility grid for nighttime electric usage. In a case where competitive electricity generation prices are higher during peak daylight hours, this customer would potentially be paying higher electric generation costs because their electricity consumption from the grid would be profiled as a standard residential consumer who requires higher electricity during daylight hours than what the customer is actually consuming.

There are several options to acquire EDC revenue meter electricity KWh consumption interval data. Another method being utilized in the present invention is an infrared sensor 26 that detects pulse counts from the EDC meter's external infrared port. The infrared port provides an externally available source for meter pulses on a real-time basis. The present invention includes a plug-in infrared sensor 26 that reads the EDC meter pulses from the infrared port (FIG. 2). An additional method for collecting customer electricity interval data is the use of current transducers 27 installed on the customer's main electricity conductors that feed the customer's main electric service entrance panel. These current transducers 27 measure current passing through the electric conductors from the EDC meter. The current measurement is collected over the specified time intervals and stored in the solid-state data storage & communications module 32.

Customer electric interval data is collected from the LPOP 24 and stored electronically in a local data storage medium (solid-state data storage & communications module 32 located at or near the EDC revenue meter). Customer electricity KWh consumption data is sent to a retail supplier (or data service provider) via a real-time communication module (wireless cellular 34 or Ethernet cable connection 36) back to a network data center 38 and energy trading desk 39. The solid-state data storage & communications module includes a connection port for both cellular 34 and 2.4 or 5.8 GHz wireless 36 transmission of data. The solid-state data storage & communication module can be powered from several sources including: (1) 120-volt power from a building outlet plug using a dedicated 120-volt to 5-volt converter 44, or a properly sized polycrystalline/monocrystalline solar photovoltaic panel 46 with a DC to DC charge controller 48 (FIG. 2). The solid-state data storage & communications module is designed with an integrated battery backup 50 that charges from both grid power in case of grid-side power outages or interruptions as well as battery storage for night-time hours if the module is powered by a solar photovoltaic panel.

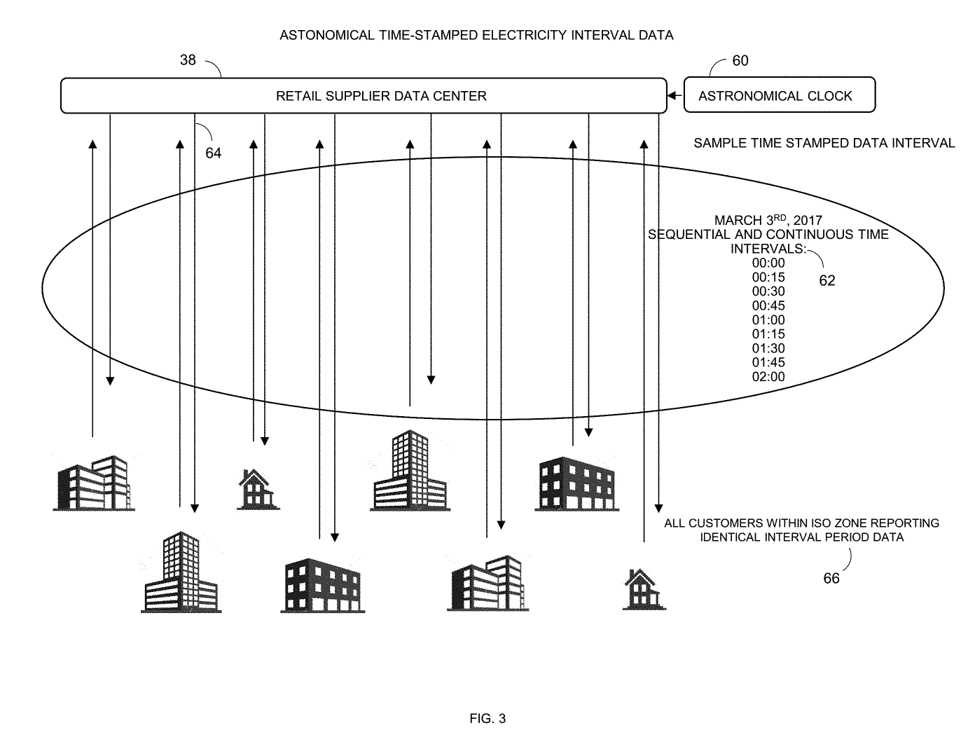

Individual customer electricity interval data is collected based on a universal time stamp from an astronomical clock 60 maintained at the retail supplier data center that ensures all aggregate customer consumption intervals is collected at the identical time interval period 66 (FIG. 3) and that time interval period coincides with the same interval period of the ISO. A typical interval setting is fifteen (15) minutes 62. On a scheduled frequency, a time verification message is sent 64 from the retail supplier central data server 38 to each customer solid-state data storage & communications module 32 to verify the time and sequence of intervals.

The collection of customer KWh consumption in specified time interval(s) allows finite collection of customer electricity consumption that typically matches the EDCs method for capturing peak electric demand measurements for purposes of billing its transmission and distribution services as well as an interval that allows for the efficient collection of data used to procure wholesale electricity with the ISO. The system has the ability to change the interval periods via communication 64 from the central data server to the solid-state data storage & communications module if required to meet ISO wholesale market procurement rules.

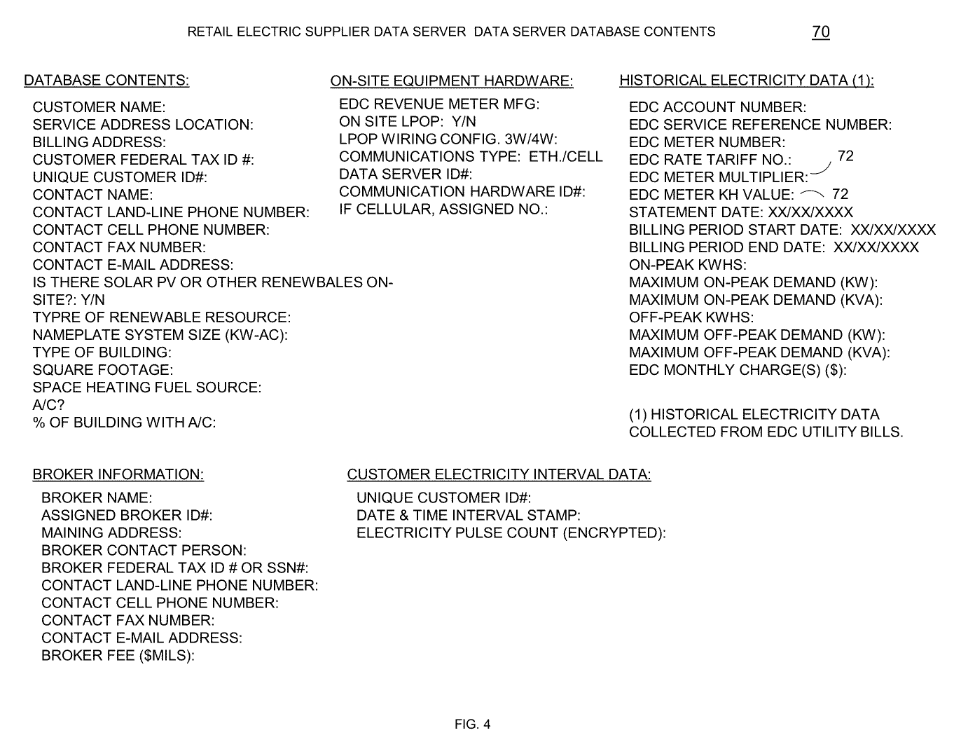

Customer KWh consumption is collected from the number of pulses that are emitted from the LPOP 24 during each interval period. The pulse counts are the basis for tracking kilowatt hours consumed during an interval period. The translation of pulses to kilowatt hours is based on a conversion formula established by the EDC revenue meter manufacturer and the EDC. The formula parameters for converting pulses to kilowatt hours 72 is collected as part of the customer information file 70 established when the retail supplier sets up a new customer account (see FIG. 4). By capturing the pulse conversion formula parameters 72 during customer acquisition, the retail supplier data server and trading desk software can quickly and efficiently convert pulse data being collected into useable electricity KWh consumption within the intervals 82.

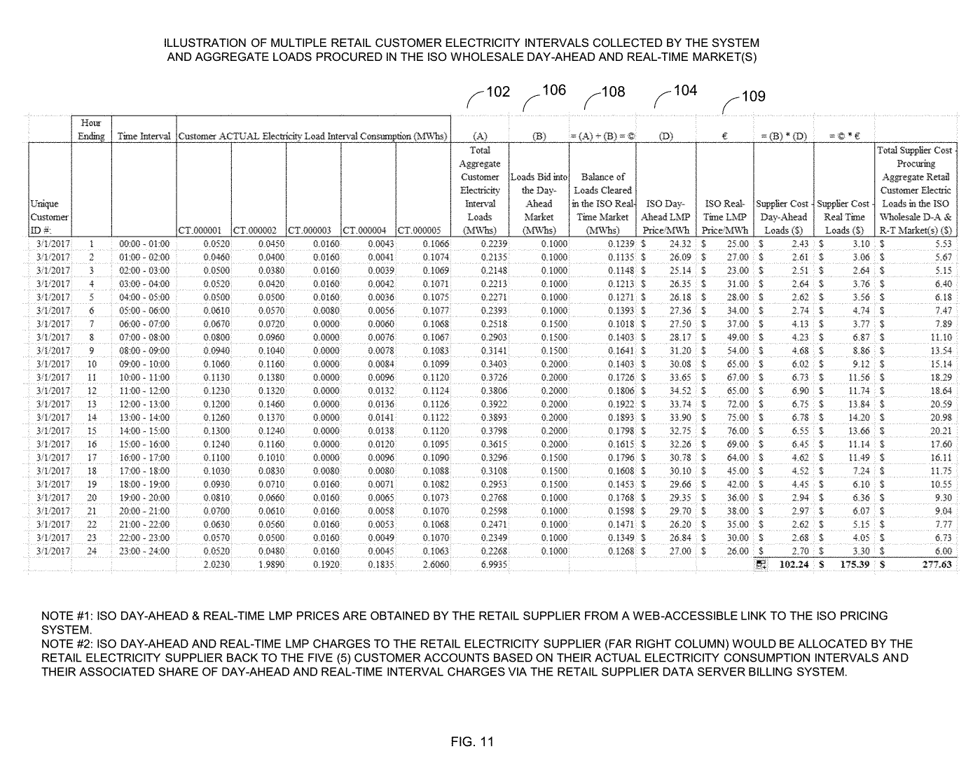

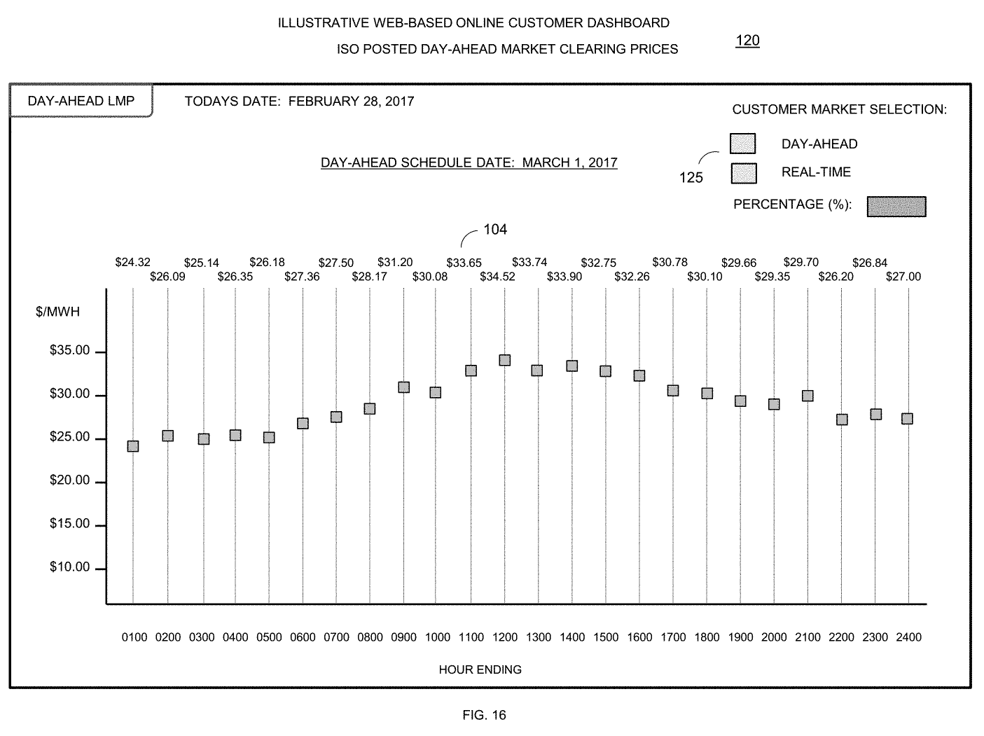

The electric retail supplier utilizes actual customer KWh interval data on an individual basis 82 and an aggregate of multiple customers 102 (FIG. 11) to procure electricity in the wholesale electric market whereby electricity KWh consumption is matched with corresponding wholesale day-ahead electric supply prices 104 and real-time electricity supply prices 109 for the corresponding time interval periods. The retail supplier is a member of the ISO power pool. As a member of the ISO, the retail supplier purchases electricity generation services in both the day-ahead and the real-time wholesale market(s). The retail supplier utilizes a central data server 38 and energy-trading desk 39 which is part of the present invention to facilitate the aggregate electricity loads that will be purchased in the day-ahead 106 and real-time markets 108 within defined intervals throughout the day. Aggregate electricity interval loads to be purchased in the day-ahead and real-time market(s) are selected by the customer 125 through a web-based customer dashboard 120 (FIG. 16).

The retail supplier has the ability to choose from several ISO wholesale market(s) to procure aggregate and individual customer energy loads. The two primary wholesale energy markets are the day-ahead market and the real-time market. The retail supplier can commit to purchasing a portion or all of a customer's energy requirements in the day-ahead wholesale market. As a member of the ISO, the retail supplier will receive day-ahead pricing 104 for the next day intervals from the ISO wholesale market electronic interface. Day-ahead hourly (or shorter) interval prices are posted in the late afternoon of the prior day.

The present invention allows the customer to receive posted day-ahead interval prices from the retail supplier via a web-browser 120 that receives day-ahead interval pricing from a connection to the retail supplier central data server 38. The retail supplier data server receives an electronic feed from the ISO 35 once day-ahead interval prices are set by the ISO through a competitive bidding process. This normally occurs in the late afternoon of the day prior to the market participation day. Customers may select their preference in participating in the day-ahead market prices 125, through a web-based dashboard 120 if they like the prices posted by the wholesale supplier market. If the customer does not choose to participate in the day-ahead market, the retail supplier will automatically clear the customer's electricity KWh consumption intervals in the real-time wholesale market at the corresponding wholesale real-time prices 109.

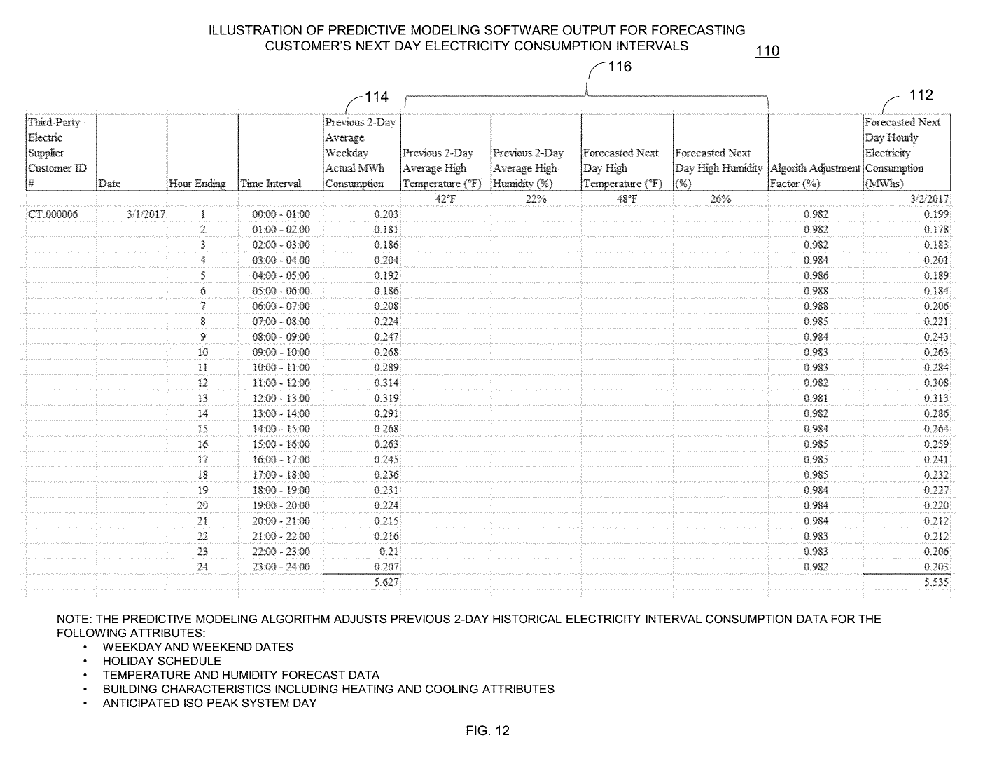

Proprietary software within the retail supplier's data server facilitates the ability to provide retail customers with published day-ahead market clearing prices (FIG. 16) for each of the interval periods 104 of the following day. Customers can select the market they would like to participate in 125 based upon day-ahead published hourly market clearing prices. The customer accesses the retail supplier web-portal using a dedicated login and password for their account(s). Customers can have multiple meter accounts and can access all of their accounts via a single login and password. For customers that are seeking to access day-ahead wholesale pricing information, the web-browser provides customers with a forecasted next-day load profile 112 (FIG. 12) for the customer based upon: (1) previous day load interval data 114, (2) weather data algorithm adjustments 116, and (3) building energy system infrastructure details. The present invention includes software that forecasts next-day customer interval consumption profile 112 utilizing proprietary algorithms within the software. The algorithms utilize a variety of both: (1) customer specific parameters including, but not limited to: (a) building or dwelling occupancy schedule(s) for weekday, weekend, and holidays, (b) building construction type and energy consuming infrastructure details (c) customer holiday, and (2) external factors including, but not limited to: (a) outside air temperature and humidity forecasts, and (b) other local and regional forecasted weather related events, and (c) ISO system aggregate peak day load forecasts.

The present invention incorporates the interface of ISO system aggregate electricity load forecast data that are received by the retail supplier on a daily basis via an electronic interface 37 between the ISO's wholesale market data system(s) and the retail supplier's central database 38 and energy trading desk 39. The ISO obtains real-time aggregate electricity demand within its geographic territory from a variety of information sources and data points. This includes minute-by-minute (or shorter intervals) electricity data from: (1) generators that are producing electricity with meter data points measuring electricity output to the grid, (2) electricity substations measuring electricity flows throughout the ISO geographic service territory, and (3) interconnection points with adjacent ISOs measuring power flows between ISO territories and other relevant ISO metered data points. The ISO utilizes these data points to measure both instantaneous demand and supply within the system in order to balance supply and demand (in the real-time market(s) and to ensure reliability at the lowest cost to serve.

ISO system aggregate peak kilowatt (KW) loads vary on a daily and seasonal basis. Changes in daily and seasonal aggregate peak demand is driven by several factors including, but not limited to: (1) weekday and weekend electricity consumption differences, especially within market segments, and (2) weather factors. Weather is a significant factor that affects both hourly and daily aggregate system electricity demand. Weather changes that affect geographic areas within an ISO service territory is also very significant. Populated areas within an ISO service territory that are affected by weather events can have a very significant impact on aggregate electricity demand. For example, a hot summer day with high humidity will result in significant increases in electricity consumption associated with air conditioning. However, high humidity also increases the likelihood of localized thunderstorms which may result in sudden drops in electricity demand depending upon where the weather event occurs or is heading and its proximity to populated areas.

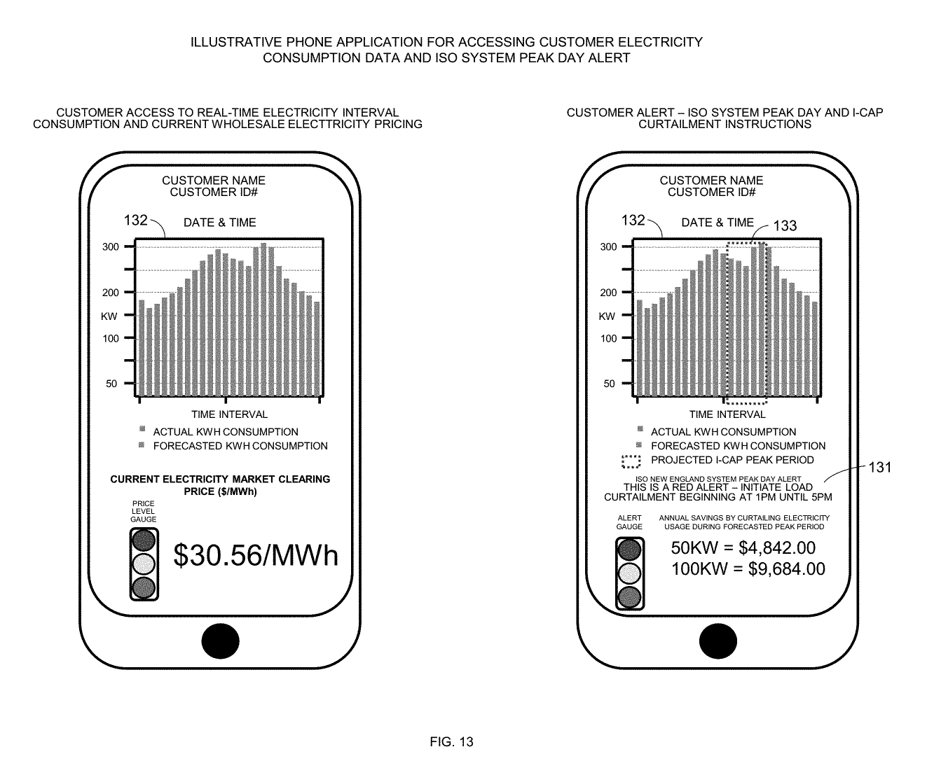

ISO system annual peak day forecast represents the forecasted day when the annual peak electricity demand of the entire system is expected to reach the highest for a given annual period. A forecasted ISO system peak day is a vital component of the present invention's software algorithms as the projected system peak day will include recommendations (phone and web-alerts) requesting customers to curtail loads 131 during time intervals where the system annual peak aggregate load may occur (FIG. 13).

The ISO forecasted system peak day establishes each individual customer's required peak capacity kilowatt value. This is commonly referred to as a capacity “tag” and represents the amount of electric capacity needed to serve that specific customer coincident with the ISO system aggregate peak demand interval. When an ISO system peak hour is reached, this hour establishes each customer's capacity tag value. The capacity tag is determined by the EDC under two circumstances. The first, is the EDC will read the customer's meter (this is done if the meter is an interval meter and has the ability to collect peak demand data for specific intervals) and determine the peak electric demand that the customer reached during the ISO system peak hour. If a customer does not have an interval meter, or the EDC cannot obtain the interval data, then the EDC will calculate a capacity tag value based upon the standard rate tariff load shape assigned to the customer via their T&D rate tariff.

The present invention includes the infrastructure 10 necessary to allow participating customers to collect electricity consumption interval data so that their peak electricity demand is not profiled by the EDC in determining their capacity tag value. The capacity tag charges for a customer can represent between ten percent (10%) and twenty-five percent (25%) of the total electric generation charge(s) paid by the customer on an annual basis. Electric generation capacity costs can vary by customer due to a number of factors including, but not limited to: (1) the customer's peak electricity demand during the ISO system peak hour, (2) the specific electricity consumption profile of the customer, (3) the auction prices of electric generation capacity (commonly referred to a Forward Capacity Market (“FCM”) auctions, and (4) the ability of the customer to curtail electricity consumption during the ISO system peak hour.

The present invention includes software that monitors and collects forecasted ISO system loads. The ISO provides daily forecasts of aggregate system loads typically for the following day as well as a three (3) to five (5) day forecast. The software collects this data to analyze the likelihood of a particular day being a potential candidate for the annual system peak. The present invention also incorporates weather forecast data for the ISO geographic territory. The software collects weather forecast data and analyzes weather parameters including: (1) outside air temperature, (2) relative humidity, and (3) locational weather patterns as they relate to the populated urban center locations. The software focuses on urban centers as these areas derive a higher concentration of peak electricity loads within an ISO geographic territory.

The present invention software includes web-accessible and phone application alerts 131 that are sent to customers with instructions to curtail electricity consumption during specific time intervals (FIG. 13). The alerts provide customers with real-time electricity consumption data 132 and the time intervals that most likely coincide with the system peak 133. Customers that curtail loads during those intervals will see a reduction in their capacity tag value and will correspondingly see reductions in their electricity generation costs (the capacity portion of their aggregate electric generation costs).

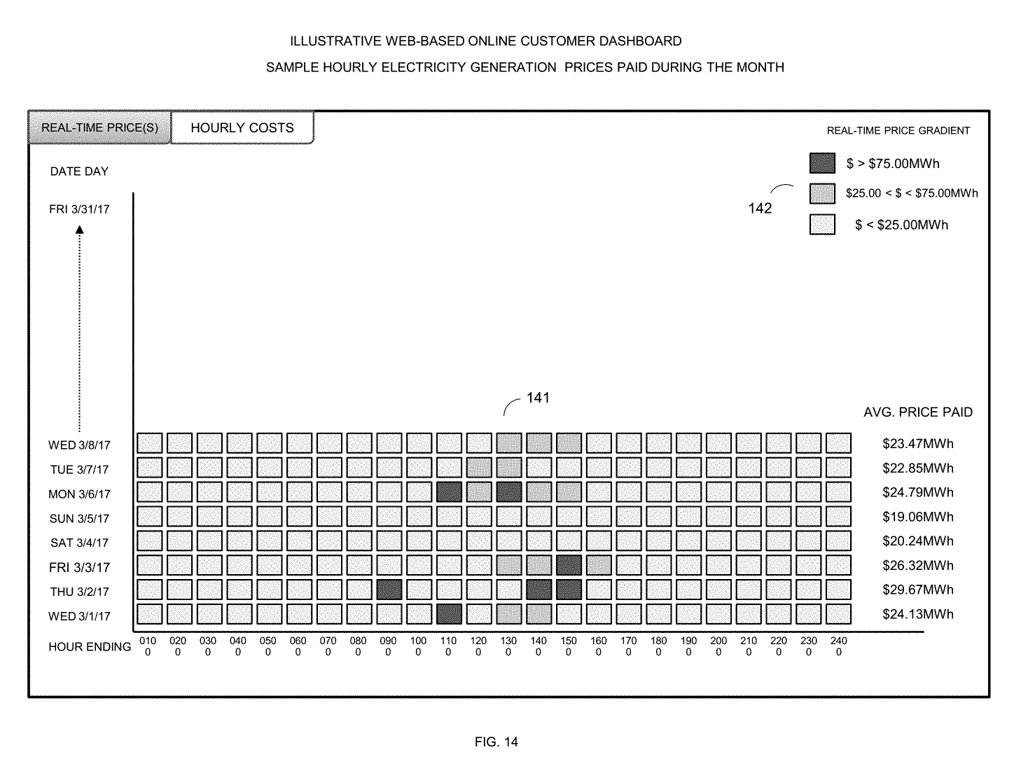

The present invention software also includes a web-accessible browser that tracks and displays customer electricity interval consumption data, interval prices paid 141, and corresponding costs 143 on an hourly, daily, and monthly basis (FIG. 14 & 15). The software provides day-ahead & real-time prices paid for corresponding hourly intervals and total hourly costs 144 incurred for the day. Customers can concisely view their electricity costs on a finite basis rather than receiving an aggregate monthly bill from their retail supplier or EDC. Customers can utilize this data to quickly assess potential inefficient electricity consumption within their business or home by accessing real-time consumption interval data as well as electricity cost data for specific intervals. In addition, industrial customers can utilize this information for accurate cost allocation associated with product production runs or municipalities can assign costs for periods where their facilities are being used by a third-party event.

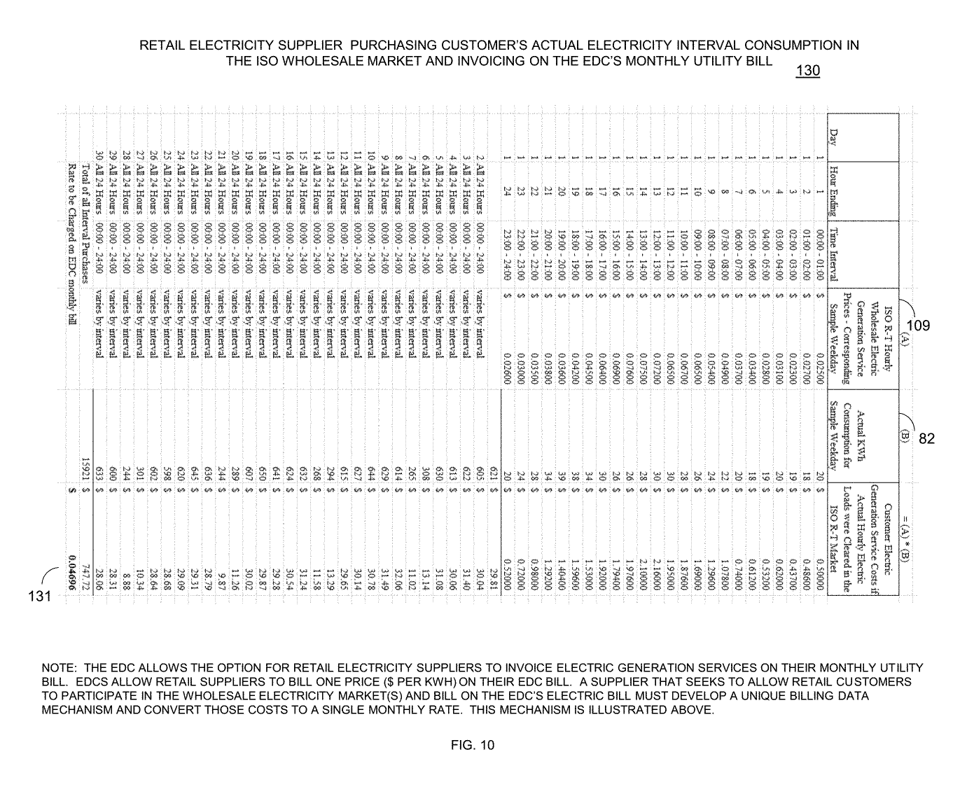

The present invention allows a retail supplier to offer dynamic interval pricing to a customer and choose to bill for electric generation services on the customer's EDC monthly utility bill. Customers have the option of receiving a separate electricity generation service bill from their retail supplier or have the retail supplier include their charges on the EDC monthly T&D utility bill. If the customer opts for receiving a single utility bill with both charges, the retail supplier must provide the EDC with a single rate per kilowatt hour for purposes of billing on the EDC bill. The present invention's data server software collects individual customer interval consumption and corresponding wholesale prices paid 130 and aggregates the customer's electricity consumption for the EDC billing period and wholesale electricity prices paid and generates an average price 131 for the EDC billing period which is sent to the EDC for inclusion on their utility bill (FIG. 10). This unique process and data collection software allows the customer to actively purchase its electricity in the dynamic wholesale market yet does not need to receive two (2) separate electricity bills if it does not choose to do so.

What is claimed:

1. A system and method for collecting customer kilowatt hour consumption interval data from the electric distribution company revenue meter for the purpose of procuring wholesale electricity generation services and comprising:
a. a local pulse output protector, or similar device to acquire electricity kilowatt hour consumption from the electric distribution company meter on a real-time basis,
b. a solid-state data storage and communication module that is powered from a standard single, phase outlet or from a solar photovoltaic module, charge controller, and battery backup if;standard outlet power is not easily accessible near the EDC revenue meter,
c. communication module that sends customer electricity interval data via a cellular or wireless connection, wherein customer electricity interval data is collected on a real-time basis at a central data server with a plurality of customer(s),
d. a software module that monitors the status of the battery providing backup power to the solid-state data storage & communications module,
e. a software algorithm residing at the central data server that remotely communicates to the solid-state data storage & communication module to synchronize time intervals with a plurality of customer locations with an astronomical time clock, and
f. a central data server and trading desk utilizing software to aggregate a plurality of customer's actual electricity interval KWh consumption to procure and clear loads through a dynamically-priced wholesale electric generation market.

2. The method of claim 1 wherein the system collects customer's electricity KWh consumption from the EDC revenue meter and records such consumption in specified time intervals on a continuous basis.

3. The method of claim 2 wherein customer's electricity consumption intervals are stored in a solid-state data storage and communication module located at the customer's facility in the vicinity of the EDC revenue meter.

4. The method of claim 3 wherein customer's electricity KWh consumption interval data is sent to a central data server via a cellular or wireless connection from the solid-state data storage & communications module on a real-time and continuous basis.

5. A system for collecting real-time electricity KWh consumption interval data comprising:
a. a central data server located remotely from a plurality of customers,
b. a plurality of customer electricity KWh consumption interval data being collected on a real-time basis from individual customer locations via a cellular or cable internet connection,
c. individual customer electricity KWh consumption interval data is collected and placed in individual secure customer electronic files within the central data server(s),
d. individual customer and a plurality of customer's actual electricity consumption interval data is compiled and utilized by the energy trading desk for purposes of procuring wholesale electricity generation services in both the day-ahead and real-time market(s),
e. individual customer and a plurality of customer's actual electricity consumption interval data is cleared through the, electric distribution company and ISO daily load settlement process through the transfer of customer's actual electric consumption interval data used for purposes of load settlement(s),
f. individual customer actual electricity consumption interval data is accessible by the customer through a secure web-browser and phone application to view real-time electricity KWh consumption interval data and historical electricity consumption interval data,
g. a central data server that receives day-ahead and real-time wholesale electricity interval pricing from the ISO and provides said interval pricing with corresponding electricity KWh consumption interval data to its customer(s) via a secure web-browser dashboard and phone application on a real-time basis,
h. a secure web-browser dashboard and phone application that provides dynamic price signals for purposes of enabling customers with real-time information to curtail electricity KWh consumption during high price intervals and intervals that may establish the customer(s)' annual I-Cap tag

6. The method in claim 5 whereby a system that collects actual customer consumption interval data and utilizes such electric consumption interval data both singularly and with a plurality of customers with identical interval periods for the purpose of purchasing electricity generation service(s) through an ISO wholesale electric market whereby electric generation prices are dynamic in nature based on an integated system of supply resources and corresponding consumer demand.

7. The method in claim 5 wherein customers gain access to dynamic ISO wholesale electric interval prices via a web-browser dashboard or phone software application that obtains its data from the central data server for purposes of displaying wholesale electricity generation service day-ahead and real-time interval prices.

8. The method in claim 5 wherein customers gain access to their real-time electricity KWh consumption interval data via a web-browser dashboard or phone software application and can visually see their energy KWh consumption and corresponding wholesale electricity generation interval price(s) in one concise application.

9. The method in claim 8 whereby customer has access to real-time energy KWh consumption interval data and corresponding wholesale electricity price(s) for said interval(s) and has the ability to curtail electricity consumption based on dynamic wholesale electric generation price signals.

10. A system software algorithm that utilizes customer's historical electricity KWh consumption interval data along with external parameters including: (1) weekday and weekend schedules, (2) holidays, and (3) weather forecast(s) in order to forecast customer's next, day electricity KWh consumption interval(s).

11. The method in claim 10 wherein the system software monitors the ISO system aggregate kilowatt load forecast(s) to determine if an annual system peak may occur and provides customers with web-browser dashboard and phone application alerts with regard to specific time intervals that may determine a customer's annual 1-Cap tag value and recommendations to curtail and minimize electricity KWh consumption during those intervals,

12. The method in claim 5 wherein a unique methodology provides for the ability to offer dynamic electric generation supply pricing to retail customers that allow customers to clear their actual KWh interval loads, not profiled loads, against corresponding wholesale market interval prices for each time interval on a real-time basis where retail customer(s) receive dynamic pricing signals and have corresponding electricity KWh consumption interval data to determine the value of curtailing or shifting electricity consumption to avoid electricity generation charges.

13. A unique method of procuring wholesale electricity with varying interval prices and actual retail customer electricity KWh consumption for the corresponding intervals whereby the aggregate cost of purchasing electric generation for a particular billing cycle and total electricity kilowatt hour consumption is used to derive a single average cost per kilowatt hour for the billing cycle period and such average cost per kilowatt hour is sent to the EDC for purposes of billing the retail supplier's services on the EDC's transmission & distribution bill.

14. The method in claim 5 wherein a system that provides customers via a web-browser dashboard and phone application with day-ahead wholesale electricity interval prices whereby the customer can choose to purchase their subsequent day electricity consumption in the day-ahead or real-time wholesale market(s).
